(19) United States
(12) Patent Application Publication
(10) Pub. No.: US 2004/0214525 A1
(43) Pub. Date: Oct. 28, 2004

(54) On-line music data providing system via bluetooth car kit

(76) Inventors: Byung-Koo Ahn, Seoul (KR); Jae-Duk Oh, Gyeonggi-do (KR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/478,565

(22) PCT Filed: Oct. 26, 2001
(86) PCT No.: PCT/KR01/01834

(30) Foreign Application Priority Data
May 23, 2001 (KR) 2001-28429

(51) Int. Cl. H04B 7/00

(52) U.S. Cl. 455/41.2; 455/569.2; 455/575.9

(57) ABSTRACT

Disclosed is an online music-data providing system via a Bluetooth car kit which comprises: a music-data providing server for providing music data through a network; a mobile communication system connected to the network; a mobile station for wirelessly accessing the mobile communication system and performing the Bluetooth protocol; and a Bluetooth car kit installed in a vehicle, having a Bluetooth function for performing the Bluetooth protocol, for performing short range radio links by the Bluetooth protocol to the mobile station, receiving the music data from the music-data-providing server through the mobile station, reproducing them, and outputting them. Since the music files distributed by the music-data-providing server are encoded, they are not transmitted or reproduced to other devices except the car kit. Further, the present invention provides various categories of contents in addition to the online music data distribution service through the car kit.

### CROSS REFERENCE TO RELATED APPLICATION

This application is based on Korea Patent Application No. 2001-28429 filed on May 23, 2001 in the Korean Intellectual Property Office, the content of which is incorporated herein by reference.

### BACKGROUND OF THE INVENTION

(a) Field of the Invention

The present invention relates to an online music-data-providing system. More specifically, the present invention relates to an online music-data-providing system via a car kit.

(b) Description of the Related Art

As online data transmission speeds have been enhanced because of dissemination of the Internet, online music data distribution services for distributing music files through the Internet have become available.

Also, wireless data terminals such as mobile stations have spread, and accordingly, wireless data communication services, and in particular, wireless Internet services using them, have increased.

The wireless Internet services support terminals that adopt the HTTP (Hyper Text Transfer Protocol) and the WAP (Wireless Application Protocol) to use the wireless Internet.

Recently, Bluetooth, a short range radio communication standard for wirelessly linking a computer and a peripheral device, a mobile station and a computer, and home appliances respectively installed within a short range with each other to thereby enable bidirectional and real-time communication has been adopted, and hardwired modules that realize Bluetooth have been distributed.

A car kit as embodied in the present invention is a car audio system and a microphone installed on it. In preparation for a voice call service as well as for data communication such as with mobile stations, a microphone is provided to a car audio system, and a user sends the user's voice using the microphone.

As the number of vehicles distributed has increased, drivers have come to drive their cars longer and they listen to music for a longer time, but most of them listen to music from radio music programs, music cassette tapes, or CDs through a car audio system installed in their own car.

### SUMMARY OF THE INVENTION

It is an object of the present invention to provide an online music-data-providing system for downloading music data to the system through a car kit on line and reproducing them in cooperation with an online music source distribution service, a wireless Internet service, and Bluetooth technology.

In one aspect of the present invention, an online music-data-providing system via a Bluetooth car kit comprises: a music-data-providing server for providing music data on line through a network; a mobile communication system connected to the network; a mobile station for wirelessly accessing the mobile communication system, and performing the Bluetooth protocol for short range links; and a Bluetooth car kit installed in a vehicle, having a Bluetooth function for performing the Bluetooth protocol, for performing short range radio links by the Bluetooth protocol to the mobile station, receiving the music data from the music-data-providing server through the mobile station, reproducing them, and outputting them.

The Bluetooth car kit comprises: a Bluetooth communication unit for performing short range radio links by the Bluetooth protocol to the mobile station; a decompressor for decoding the music data received from the mobile station through the Bluetooth communication unit, and decompressing them; an audio output unit for processing the music data decompressed by the decompressor, reproducing them, and outputting them so that a user may listen to them through a plurality of speakers; a voice coder, comprising a microphone for receiving an external voice and outputting a corresponding voice signal, for processing the voice signal output through the microphone and outputting the same; and a controller for controlling the Bluetooth communication unit, the decompressor, the audio output unit, and the voice coder to control the whole operation of the car kit.

The mobile station comprises: a wireless transmitting and receiving unit for receiving the music data from the music-data-providing server through radio links to the mobile communication system; a user interface for receiving a user instruction, outputting it, and displaying predetermined information to the user; a Bluetooth communication unit for performing short range radio links by the Bluetooth protocol to the Bluetooth car kit; and a controller for controlling the wireless transmitting and receiving unit, the user interface, and the Bluetooth communication unit to control the whole operation of the mobile station.

### BRIEF DESCRIPTION OF THE DRAWINGS

The accompanying drawings, which are incorporated in and constitute a part of the specification, illustrate an embodiment of the invention, and, together with the description, serve to explain the principles of the invention.

FIG. 1 shows a block diagram of an online music-data-providing system via a car kit according to a preferred embodiment of the present invention;

FIG. 2 shows a detailed block diagram of a mobile station and a car kit in the online music-data-providing system of FIG. 1; and

FIGS. 3(a) and 3(b) show an operation flowchart of the online music-data-providing system via a car kit according to a preferred embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

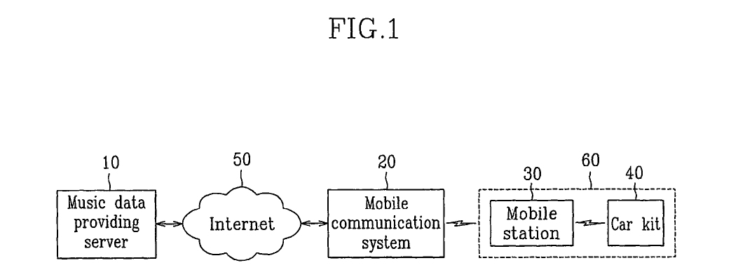

FIG. 1 shows a block diagram of an online music-data-providing system via a car kit according to a preferred embodiment of the present invention.

As shown, the online music-data-providing system via a car kit comprises a music-data-providing server 10; a mobile communication system 20; a mobile station 30; and a car kit 40.

The music-data-providing server 10 stores a plurality of music data, and transmits stored music data to the mobile station through the Internet 50 according to a download request by a member user that is a mobile station user.

The user accesses the music-data-providing server 10 through the mobile station 30. In this instance, the mobile station 30 is wirelessly connected to the mobile communication system 20, and the mobile communication system 20 is connected to the music-data-providing server 10 through the Internet 50.

The car kit 40 is installed in the user's car 60, and is connected to the mobile station 30 that is temporarily positioned in the car 60 through a short range radio link by the Bluetooth protocol.

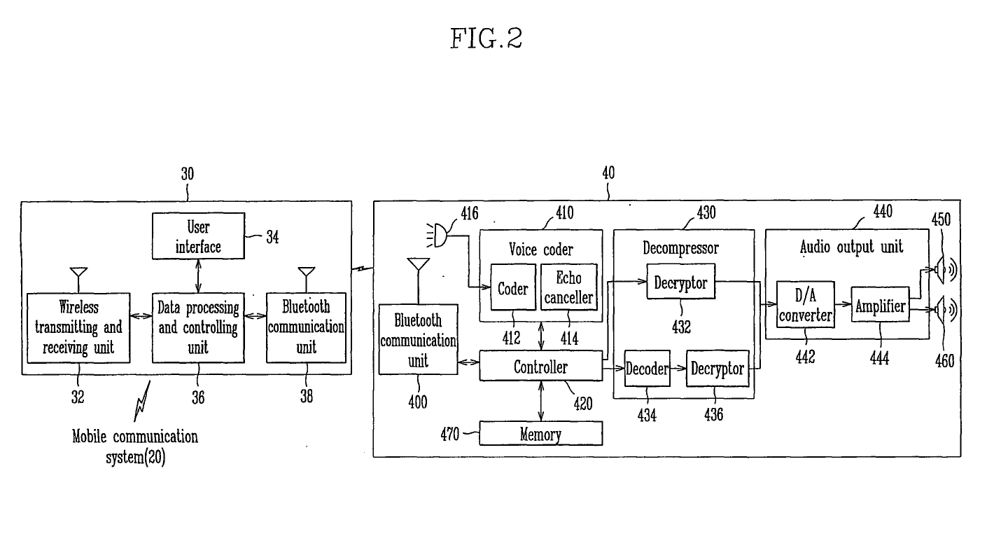

FIG. 2 shows a detailed block diagram of the mobile station 30 and the car kit 40 in the online music-data-providing system of FIG. 1.

As shown, the mobile station 30 comprises a wireless transmitting and receiving unit 32; a user interface 34; a data processing and controlling unit 36; and a Bluetooth communication unit 38.

The wireless transmitting and receiving unit 32 enables the mobile station 30 to process data, and enables radio links between the data processing and controlling unit 36 and the mobile communication system 20.

The user interface 34 connects the user to the data processing and controlling unit 36, and it comprises an LCD and a key input device.

The Bluetooth communication unit 38 enables short range radio links by the Bluetooth protocol between the data processing and controlling unit 36 and the car kit 40.

The data processing and controlling unit 36 processes the data input by the mobile communication system 20 through the wireless transmitting and receiving unit 32 to output them to the user interface 34 or output them to the car kit 40 through the Bluetooth communication unit 38, processes the data input from the car kit 40 through the user interface 34 or the Bluetooth communication unit 38 to wirelessly transmit them to the mobile communication system 20 through the wireless transmitting and receiving unit 32, thereby controlling the whole operation of the mobile station 30.

In this instance, the Bluetooth communication unit 38 follows technology specifications, standardized by the Bluetooth SIG (Special Interest-Group), a technique standardizing consortium, for short range radio links (2.4 GHz ISM Open Band) between portable devices such as a mobile station and a mobile computer and other peripheral devices with small size, low cost, and low power consumption.

The car kit 40 comprises a Bluetooth communication unit 400; a voice coder 410; a controller 420; a decompressor 430; an audio output unit 440; and speakers 450 and 460.

The Bluetooth communication unit 400 enables short range radio links by the Bluetooth protocol between the mobile station 30 and the controller 420 of the car kit 40. That is, the Bluetooth communication unit 400 forms a call path by the Bluetooth protocol to the Bluetooth communication unit 38 of the mobile station 30.

The Bluetooth call path includes an asynchronous call path for transmitting data, and a synchronous call path for transmitting voice signals. The voice coder 410 comprises a coder 412 for converting voice signals input through the microphone 416 into digital signals, the voice signals being used for browsing contents such as telephone calls on a voice basis; and an echo canceller 414 for canceling the speaker sound input to the microphone.

The decompressor 430 decrypts and decompresses the music data encrypted and compressed by the music-data-providing server 10.

The music-data-providing server 10 may transmit streaming music data and non-streaming general music data according to the user's selection.

The streaming music data may be reproduced when the corresponding data are not completely received, and the general music-data may be reproduced when they are completely received.

Therefore, the decompressor 430 decompresses the data differently according to data types input by the music-data-providing server 10, that is, depending on whether it is streaming music data or general music data.

The decompressor 430 comprises a decryptor 432 for decompressing the streaming music data; a decoder 434 for decoding the general music data; and a decryptor 436 for decompressing the data decoded by the decoder 434.

The controller 420 controls the Bluetooth communication unit 400 to form a call path to the Bluetooth communication unit 38 of the mobile station 30, and processes the data input by the mobile station 30 to output them to the decompressor 430, thereby controlling the whole operation of the car kit 40.

The audio output unit 440 outputs the music data output by the decompressor 430 so that the user may listen to them through the two speakers 450 and 460. The audio output unit 440 comprises a D/A converter 442 for converting the music data output by the decompressor 430 into analog signals; and an amplifier 444 for amplifying the analog signals output by the D/A converter 442 to output to the speakers 450 and 460.

The controller 420 comprises a memory for storing music data and other data transmitted by the mobile station 30.

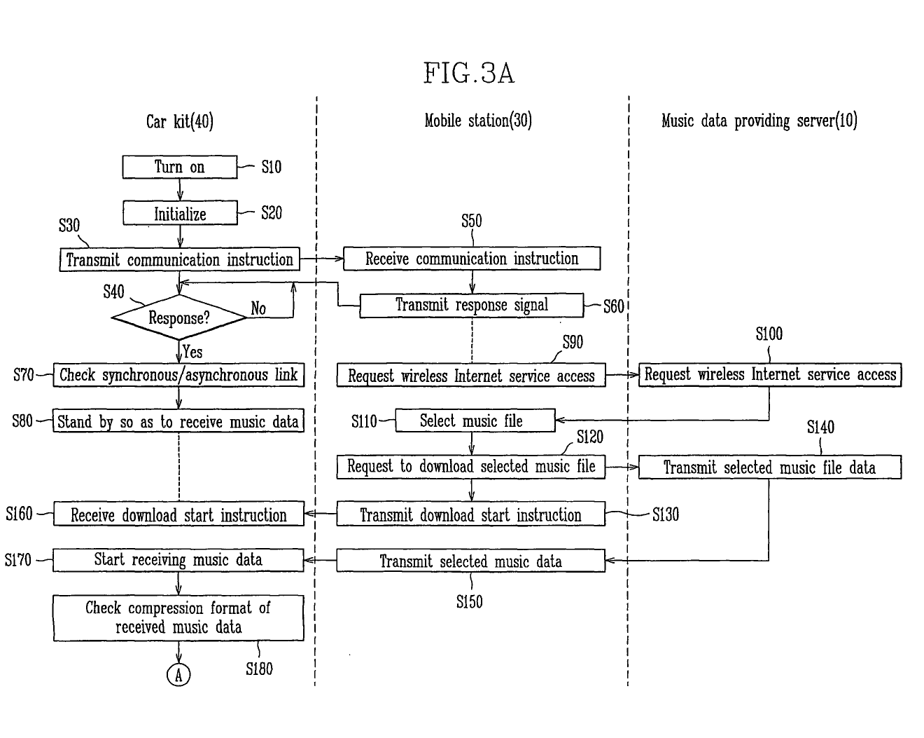

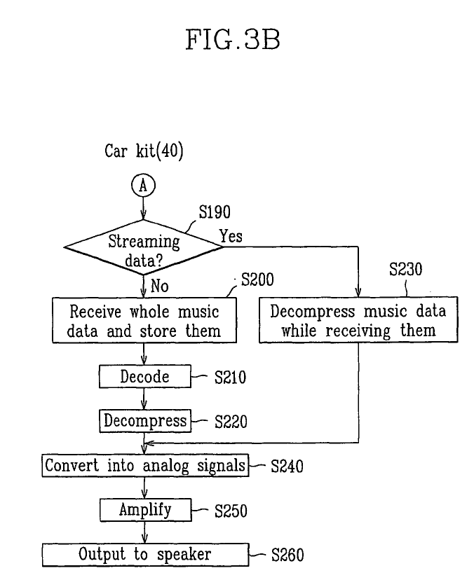

Referring to FIGS. 3(a) and 3(b), an operation of the online music providing system via a car kit according to the preferred embodiment of the present invention will now be described.

It is assumed that the user of the mobile station 30 is previously registered to the music-data-providing server 10 through the car kit 40. An operation to enter a server or a site that provides predetermined services as a member is obvious to a skilled person.

When the user turns on the car kit 40 installed in the car 60 in step S10, the car kit 40 performs its own initialization process in step S20.

In this instance, the initialization process enables the controller 420 of the car kit 40 to check states of respective components in the car kit 40, and the controller 420 provides communication instructions to the Bluetooth communication unit 400 and the mobile station 30 after the initialization process in step S30.

The car kit 40 enters a standby state of a response signal from the mobile station 30 in step S40.

The mobile terminal 30 receives the communication instruction from the Bluetooth communication unit 400 of the car kit 40 in step S50, and transmits a response signal to the communication instruction to the car kit 40 in step S60.

In further detail, when receiving the communication instruction by the Bluetooth communication protocol from the Bluetooth communication unit 400 of the car kit 40, the Bluetooth communication unit 38 of the mobile station 30 transmits this fact to the data processing and controlling unit 36, and the data processing and controlling unit 36 controls the Bluetooth communication unit 38 to transmit a response to the communication instruction transmitted by the car kit 40 to the Bluetooth communication unit 400 of the car kit 40.

The Bluetooth communication unit 400 of the car kit 40 receives the response signal from the Bluetooth communication unit 38 of the mobile station 30, transmits the same to the controller 420, and the controller 420 checks synchronous/asynchronous link states to the mobile station 30 in step S70, and when the synchronous/asynchronous link states are normal, it stands by until the music data are downloaded from the mobile station 30 in step S80.

The user requests wireless Internet access from the music-data-providing server 10 through the user's mobile station 30 in step S90, and the music-data-providing server 10 determines whether the user is registered regarding the access request by the mobile station 30, and issues an access allowance in step S100.

When receiving the access allowance from the music-data-providing server 10, the user uses the mobile station 30 to select each desired music file or a plurality of music files in step S110.

The user transmits a request to download the selected music file data to the music-data-providing server 10 in step S120, and concurrently transmits an instruction to the car kit 40 to notify of a start of downloading the music data in step S130.

The music-data-providing server 10 wirelessly transmits the selected music file data to the user's mobile station 30 according to the corresponding downloading request through the mobile communication system 20 connected to the Internet 50 in step S140, and the mobile station 30 receives the music file data from the music-data-providing server 10 and transmits them to the car kit 40 in step S150.

When receiving the instruction to notify of the start of downloading data from the mobile station in step S160, the controller 420 of the car kit 40 stands by so as to receive the music data from the mobile station 30, and when the mobile station 30 transmits the music data, the controller 420 receives the music data, stores them in the memory 470 in step S170, and checks the compression format of the music data in step S180.

When the compression format of the received music data is not the streaming type but the general type in step S190, the controller receives the total music data and stores the same in the memory 470 in step S200.

The decoder 434 of the decompressor 430 decodes the general music data stored in the memory 470 in step S210, and the decryptor 436 decompresses the decoded music data and outputs them to the audio output unit 440 in step S220.

When the compression format of the received music data in the previous step S190 is a streaming type, the controller 420 receives the music data and transmits them to the decompressor 430, and the decryptor 432 of the decompressor 430 decompresses the transmitted music data and outputs them to the audio output unit 440 in step S230.

The D/A converter 442 of the audio output unit 440 converts the digital music data output by the decompressor 430 into analog signals of the audible frequency band, and outputs them in step S240, and the amplifier 444 amplifies the analog signals in step S250, and outputs them so that the user may listen to the same from the two speakers 450 and 460 in step S260.

When a third person calls the user's mobile station 30 while the user is listening to music selected through the car kit 40 after the above-described process, in other words, when an external voice call access is requested, the data processing and controlling unit 36 of the mobile station 30 notifies the controller 420 of the car kit 40 of the external voice call access request, the controller 420 temporarily or completely stops the present music reproducing operation, and when the user uses the user interface 34 to connect to the external voice call access, the car kit 40 operates as a hands-free function of the mobile station 30.

In this instance, the music being reproduced is stopped when the user presses a call button provided to the user interface 34 of the mobile station 30 or presses the same provided to the car kit 40. The technical scope of the present invention is not restricted to this, and further various methods may be implemented.

When the user presses the call button (not illustrated) installed in the car kit 40, this fact is transmitted to the controller 420, and the controller 420 performs a process depending on the operation status of the car kit 40. For example, when the user receives a telephone call request while reproducing the music data, and presses a call button, the music data are stopped temporarily or completely. In the like manner, when the user presses the call button again after the telephone call is finished, the stopped music data may be reproduced again.

When the reproduced music is stopped, an external telephone call connection is performed, and the user speaks through the microphone 416 of the voice coder 410, the coder 412 converts the user's voice into corresponding digital signals and outputs them to the controller 420, and the controller 420 transmits the converted voice signals to the mobile station 30 to be transmitted to the third person. In this instance, the echo canceller 414 cancels the speaker sound input through the microphone 416.

Also, when the third person's voice data are transmitted to the car kit 40 through the mobile station 30, the controller 420 outputs the voice data through the speakers 450 and 460 so that the user may listen to the third person's voice.

When someone calls the user while the user is reproducing music data, the user may answer the phone according to the above-noted operation, and the temporarily paused music data may be reproduced according to the user's predetermined action, such as pressing the call button after the telephone call is finished.

In the above, a case when an external call is provided while music data are reproduced is described, and further, when someone calls the user while the user is receiving desired music file data from the music-data-providing server 10, the user may completely or temporarily stop receiving the music file data as described above, answer the phone, and start receiving the music file data that was completely or temporarily stopped after the call is finished.

According to the present invention, since the music files distributed by the music-data-providing server 10 are encoded, they may not be transmitted or reproduced to other devices except the car kit 40.

Further, the present invention may provide various categories of contents in addition to the online music data distribution service through the car kit 40.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. An online music-data-providing system via a Bluetooth car kit, comprising:
a music-data-providing server for providing music data on line through a network;
a mobile communication system connected to the network;
a mobile station for wirelessly accessing the mobile communication system, and performing the Bluetooth protocol for short range links; and
a Bluetooth car kit installed in a vehicle, having a Bluetooth function for performing the Bluetooth protocol, for performing short range radio links by the Bluetooth protocol to the mobile station, receiving the music data from the music-data-providing server through the mobile station, reproducing them, and outputting them,
wherein the Bluetooth car kit is capable of reproducing the music data in real-time while receiving the music data from the music-data-providing server.

2. The system of claim 1, wherein the Bluetooth car kit comprises:
a Bluetooth communication unit for performing short range radio links by the Bluetooth protocol to the mobile station;
a decompressor for decoding the music data received from the mobile station through the Bluetooth communication unit, and decompressing them;
an audio output unit for processing the music data decompressed by the decompressor, reproducing them, and outputting them so that a user may listen to them through a plurality of speakers;
a voice coder, comprising a microphone for receiving an external voice and outputting a corresponding voice signal, for processing the voice signal output through the microphone and outputting the same; and
a controller for controlling the Bluetooth communication unit, the decompressor, the audio output unit, and the voice coder to control the whole operation of the car kit.

3. The system of claim 2, wherein the music-data-providing server provides streaming music data and general music data, and the decompressor determines types of the music data provided by the music-data-providing server to perform a decompression operation.

4. The system of claim 3, wherein the decompressor decompresses the music data in real-time while receiving the music data from the mobile station and outputs them to the audio output unit when the music data are streaming music data, and the decompressor decodes the music data and decompresses them after the music data are completely transmitted from the mobile station when the music data are general music data.

5. The system of claim 4, wherein the decompressor comprises:
a first decryptor for decompressing streaming music data;
a decoder for decoding general music data; and
a second decryptor for decompressing the music data decoded by the decoder.

6. The system of claim 2, wherein the voice coder comprises:
a coder for converting the voice signal output from the microphone into digital signals; and
an echo canceller for canceling the speaker sound input to the microphone.

7. The system of claim 2, wherein the audio output unit comprises:
a D/A converter for converting the music data decompressed by the decompressor into analog signals; and
an amplifier for amplifying the analog signals output by the D/A converter and outputting them to the speaker.

8. The system of claim 1, wherein the mobile station comprises:
a wireless transmitting and receiving unit for receiving the music data from the music-data-providing server through radio links to the mobile communication system;
a user interface for receiving a user instruction, outputting it, and displaying predetermined information to the user;
a Bluetooth communication unit for performing short range radio links by the Bluetooth protocol to the Bluetooth car kit; and
a controller for controlling the wireless transmitting and receiving unit, the user interface, and the Bluetooth communication unit to control the whole operation of the mobile station.

9. The system of claim 1, wherein when an external telephone call request is provided to the mobile station while the Bluetooth car kit receives predetermined music data from the music-data-providing server and reproduces them, the Bluetooth car kit temporarily or completely stops reproducing the predetermined music data, and performs a hands-free function on the mobile station.

10. The system of claim 9, wherein the temporarily stopped music data are reproduced again after the external telephone call is finished.

11. The system of claim 1, wherein when an external voice call access request is provided to the mobile station while the Bluetooth car kit receives predetermined music data from the music-data-providing server, the Bluetooth car kit temporarily or completely stops receiving the predetermined music-data and performs a hands-free function on the mobile station.

12. The system of claim 11, wherein the temporarily stopped music data are received again after the external telephone call is finished.

13. A mobile station comprising:
a wireless transmitting and receiving unit for receiving music data from a music-data-providing server through radio links to a mobile communication system connected through a network to the music-data-providing server that provides music data;
a user interface for receiving a user instruction, outputting it, and displaying predetermined information to the user;
a Bluetooth communication unit for performing short range radio links by the Bluetooth protocol to the Bluetooth car kit; and
a controller for controlling the wireless transmitting and receiving unit, the user interface, and the Bluetooth communication unit to transmit the music data provided by the music-data-providing server to the Bluetooth car kit, and controlling the Bluetooth car kit to perform a hands-free function,
wherein when an external telephone call request is provided to the mobile station while the mobile station is transmitting predetermined music data to the Bluetooth car kit, the controller of the mobile station temporarily or completely stops transmitting the predetermined music data to the Bluetooth car kit and controls the Bluetooth car kit to perform a hands-free function on the mobile station.

14. A Bluetooth car kit for receiving external compressed music data and reproducing the same, comprising:
a Bluetooth communication unit for performing short range radio links by the Bluetooth protocol to a mobile station that receives the compressed music data from a predetermined music-data-providing server through radio data links;
a decompressor for decoding the compressed music data received from the mobile station through the Bluetooth communication unit, and decompressing them;
an audio output unit for processing the music data decompressed by the decompressor, reproducing them, and outputting them so that a user may listen to them through a plurality of speakers;
a voice coder, comprising a microphone for receiving an external voice and outputting a corresponding voice signal, for processing the voice signal output through the microphone and outputting the same; and
a controller for controlling the Bluetooth communication unit, the decompressor, the audio output unit, and the voice coder to reproduce the compressed music data received from the mobile station so that a user may listen to them, and performing a hands-free function of the mobile station through the microphone and the speaker,
wherein the controller controls the decompressor to output the decoded music data to the audio output unit in real-time and the audio output unit to reproduce the outputted music data in real-time while receiving the music data from the music-data-providing server.

15. An online music data providing method via a Bluetooth car kit, comprising:
a user wirelessly accessing a music-data-providing server through a mobile station, the mobile station being wirelessly connected to a mobile communication system accessed to the music-data-providing server;
the user selecting a music file through the mobile station from among the music files provided by the music-data-providing server;
the music-data-providing server providing data of the music file selected by the user to the mobile station;
the mobile station receiving the music data from the music-data-providing server, and transmitting the same to the Bluetooth car kit, the Bluetooth car kit being connected to the mobile station through short range radio links by the Bluetooth protocol; and
the Bluetooth car kit decompressing and reproducing the music data transmitted from the mobile station,
wherein the Bluetooth car kit is capable of decompressing and reproducing the music data in real-time while receiving the music data from the music-data-providing server.

16. An agency method for providing music data by a mobile station comprising:
a mobile station accessing a music-data-providing server through radio links to a mobile communication system;
requesting the music-data-providing server to provide data on the file selected by the user from among the music files provided by the music-data-providing server; and
receiving the music data from the music-data-providing server, and transmitting them to the Bluetooth car kit, the Bluetooth car kit being connected to the mobile station through short range radio links by the Bluetooth protocol and reproducing the music data transmitted from the mobile station,
wherein when an external telephone call request is provided to the mobile station while the mobile station is transmitting predetermined music data to the Bluetooth car kit, the mobile station temporarily or completely stops transmitting the predetermined music data to the Bluetooth car kit and controls the Bluetooth car kit to perform a hands-free function on the mobile station.

17. A method for receiving and reproducing provided music data by a Bluetooth car kit comprising:
the Bluetooth car kit accessing a mobile station through short range radio links by the Bluetooth protocol;
receiving music data through the short range radio links from a mobile station that receives the music data from a music-data-providing server, the mobile station wirelessly accessing the music-data-providing server through a mobile communication system connected to the music-data-providing server through a network to receive the music data from the music-data-providing server;
decompressing the music data transmitted from the mobile station; and
reproducing the decompressed music data,
wherein the Bluetooth car kit is capable of decompressing and reproducing the music data in real-time while receiving the music data from the music-data-providing server.
